(19) United States
(12) Patent Application Publication
(10) Pub. No.: US 2003/0035007 A1
(43) Pub. Date: Feb. 20, 2003

(54) ARCHITECTURE FOR CONVERGENCE SYSTEMS

(76) Inventor: THEODORE D. WUGOFSKI, FORT WORTH, TX (US)

Correspondence Address: GATEWAY, INC., 14303 GATEWAY PLACE, ATTENTION: MARK WALKER (MAIL DROP SD-21), POWAY, CA, 92064, US

(21) Appl. No.: 09/002,828

(22) Filed: Jan. 5, 1998

(51) Int. Cl. G09G 5/00

(52) U.S. Cl. 345/764

(57) ABSTRACT

An architecture for convergence systems is disclosed. In one embodiment of the invention, the architecture includes views, overlays, and system services. The views each provide a graphical user interface. The overlays each provide a partial graphical user interface cooperating with and consistent over the views. The system services each provide common functionality and/or user interfaces shared by the views and the overlays.

### RELATED APPLICATIONS

This application is related to the following co-pending, co-assigned, and co-filed applications: “System and method for reminding users of upcoming scheduled recordings,” “Method for managing multiple channel maps from multiple input devices in a multimedia system,” “Previous, favorite, and frequent channel management system,” “System for time-shifting events in a multi-channel convergence system,” “System, apparatus, and method for tuning a television to a selected channel,” “A system for resolving channel selection in a multi-channel convergence system,” “A System for managing favorite channels,” “System for using a channel and event overlay for invoking channel and event related functions,” “Multipurpose channel banner,” “Controlling the layout of graphics in a television environment,” “Mutatably transparent controls,” “Displaying layered information using lenticular-like interfaces,” “Method and system for associating web sites to television programs,” “Individualized parameter control for multiple media sources in a data processing system,” “System for scheduled caching of in-band data services,” “System for Combining Electronic Program Guide Data,” and “Integration of Internet sources into an electronic program database list,” all of which are hereby incorporated by reference.

### FIELD OF THE INVENTION

The present invention relates generally to convergence systems and more particularly to an architecture for such systems.

### BACKGROUND OF THE INVENTION

A convergence system refers to a system that includes capabilities that otherwise are provided by separate systems. For example, the Gateway Destination PC/TV system, available from Gateway 2000, Inc., provides for both computer and television capability. Rather than forcing users to have both a separate television and a separate computer, convergence systems such as the Destination PC/TV system permit users to utilize both television and computer capability within the same system.

Convergence systems are believed by many industry pundits to represent the future of consumer electronics. Rather than having a computer in a den, and other, separate devices scattered in other rooms throughout their homes, consumers may instead have a convergence system integrating the functionality of both the computer and these separate devices. For example, convergence systems such as the Destination PC/TV system permit consumers to combine computer capability with the capability of such varying devices as digital video disc (DVD) players, direct broadcast satellite (DBS) receivers, TV tuners (for broadcast and/or cable TV), CD-ROM players, audio/visual tuners having at least radio tuning capability, cable decoders, video cassette recorders, laser and compact disc players, video cameras, etc.

However, a significant problem to developing flexible convergence systems is inherent in the very nature of such systems. For convergence systems to be truly useful to users, they must be able to integrate the capabilities of such devices as listed above; thus, as new devices are desired to be added to a convergence system, the developers of the system must be able to easily and quickly adapt the system to the new devices. New features should be able to be added to the convergence system without affecting existing features of the system, and moreover should be consistent with the existing features. If rapid, easy and relatively error-free development of convergence systems is not possible, users may find their usefulness wanting, and ultimately may not readily adopt the systems.

### SUMMARY OF THE INVENTION

The above-identified shortcomings as well as other problems are addressed by the present invention, which will be understood by reading and studying the following specification. The invention describes a software architecture for convergence systems. In one embodiment of the invention, the architecture includes views, overlays, and system services. The views each provide a graphical user interface, which may be associated with a particular application or applications. The overlays each provide a partial graphical user interface cooperating with and consistent over the views. Finally, the system services each provide common functionality and/or user interfaces shared by the views and the overlays.

In this manner, the invention provides a modular architecture that enables rapid, easy and relatively bug-free development of convergence systems. For example, once the overlays and system services are developed for a given architecture, new views can be easily added to take advantage of these overlays and services, without having to expend effort to ensure their consistency with existing views—since the overlays provide user interfaces consistent over all the views, and since the services provide functionality and interfaces common to and shared by the views. Furthermore, for existing application programs each having their own view, new functionality can be easily added by developing a new service, rather than coding the functionality into each existing program. Overlays, services, and views may themselves also be modular, providing further flexibility.

In different embodiments of the invention, computers, computerized systems, and software architecture of varying scope are described. Still other and further embodiments, aspects and advantages of the invention will become apparent by reference to the drawings and by reading the following detailed description.

### BRIEF DESCRIPTION OF THE DRAWINGS

FIG. 1 is a diagram of a computerized system according to one embodiment of the invention;

FIG. 2 is a diagram of a software architecture, according to one embodiment of the invention;

FIG. 3 is a diagram of a typical computer in conjunction with which embodiments of the invention may be implemented; and,

FIGS. 4(a)-4(n) are diagrams showing in more detail a software architecture according to one embodiment of the invention.

### DETAILED DESCRIPTION OF THE INVENTION

In the following detailed description of the preferred embodiments, reference is made to the accompanying drawings which form a part hereof, and in which is shown by way of illustration specific preferred embodiments in which the inventions may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense, and the scope of the present invention is defined only by the appended claims.

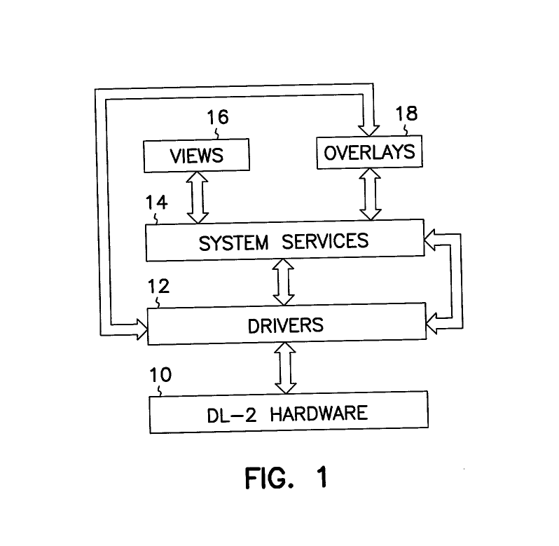

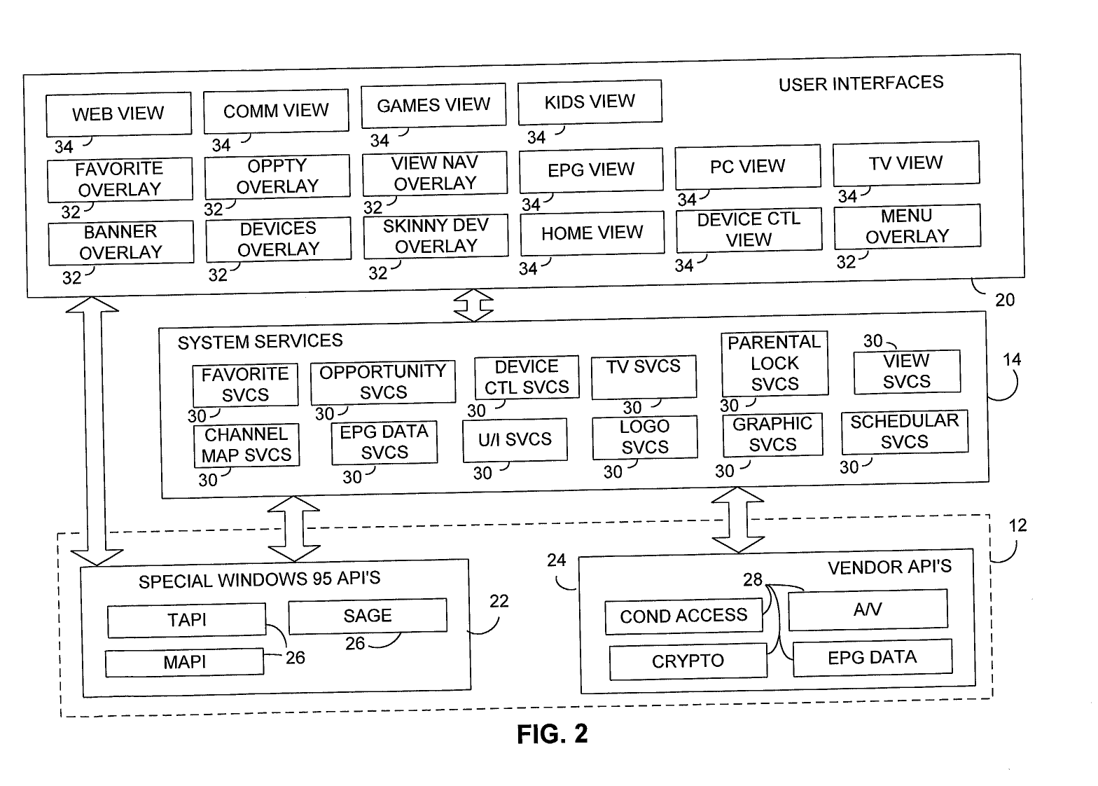

Referring first to FIG. 1, a diagram of a computerized system according to one embodiment of the invention is shown. The computerized system includes hardware component 10, drivers component 12, system services component 14, views component 16, and overlays component 18. Each of these components is described in general in relation to FIG. 1, and is subsequently described in more detail in relation to FIG. 2. Drivers component 12, system services component 14, views component 16, and overlays component 18 constitute the inventive software architecture according to one embodiment of the invention. In this embodiment, hardware component 10 acts as the hardware in conjunction with which the software architecture operates. The computerized system of FIG. 1 is modular, providing default behaviors and default graphical user interfaces, but allowing applications to specifically replace any or all of the behaviors or graphical user interfaces.

Hardware component 10 includes the necessary hardware to provide for what is known in the art as a “convergence environment” in which a personal computer (PC) is integrated with other capability, such as and usually including at least television (TV) capability. Such hardware components are known and available within the art. For example, the Gateway Destination PC/TV system, available from Gateway 2000, Inc., provides a convergence environment across two primary modes of operation: TV viewing, and PC operation (i.e., such that the system provides TV and PC capability).

Drivers component 12 provides a plurality of drivers, which include low-level functionality that cooperate directly with hardware component 10 of the computerized system. The drivers thus provide the manner by which the other components of the software architecture interface with hardware component 10. The drivers act as the lowest level of abstraction within the software architecture. Examples of drivers include application programming interfaces (API's), as known within the art, such as those available within Microsoft Windows, as well as those available from other parties.

Systems services component 14 interfaces with drivers 12 to provide a plurality of system services, which include functions and user interfaces shared by multiple views provided by views component 16 and multiple overlays provided by overlays component 18. System services also include functions that may provide a hardware abstraction layer that is not provided by the drivers of drivers component 12. That is, system services component 14 provides a hardware abstraction layer so that views component 16 and overlays component 18 do not have to directly access hardware component 10 or drivers component 12, and/or also provides a set of commonly used functions and user interfaces to views component 16 and overlays component 18.

View component 16 provides a plurality of views, which are full-screen graphical user interfaces that define a context for a user of the computerized system. Examples of views include a full-screen TV window, in which a television station may be viewed (and thus providing a TV context), and the standard PC window, such as a windows desktop in the case of Microsoft Windows 95 (and thus providing a PC context). Other views include a web browser view, which permits a user to view worldwide-web Internet pages, and an electronic program guide (EPG) view, as known within the art. Views are graphical user interfaces that may be associated with a given application or applications, and are specific to that application or applications. A web browser view, for example, is specific to a web browser application, and does not relate to an electronic program guide application. Thus, views each provide a context, such as a PC or TV context, the invention is not particularly limited to a set of given contexts. There also may be more than one view, as those of ordinary skill within the art can appreciate.

Overlays component 18 provides a plurality of overlays, which are partial screen graphical user interfaces displayed consistently across all views and modes of operation. That is, while a view is specific to a given application—such as a TV window, or a PC window—an overlay is displayed regardless of the selected view. It is laid over the current view, and is not necessarily specific to the view. Examples of overlays include a channel banner, which displays the current channel which is being tuned to, and a favorites list, which displays a list of favorite channels. Thus, even if a user switches from a web browser view to an electronic program guide (EPG) view, a given overlay may nevertheless still be displayed. Note that both overlays and views are considered user interfaces of the software architecture, and overlays component 18 and view component 16 may be conceptualized as a user interface component.

The division of the software architecture into drivers, system services and user interfaces (views and overlays) extends modularity to the architecture. Thus, the addition of a new user interface, such as a new view or overlay, does not require the development of an entirely new software architecture, and furthermore does not require the modification of existing drivers, system services, and user interfaces. A specific existing software architecture according to an embodiment of the invention therefore is amenable to further expansion or change, with minimal disruption and modification.

Referring next to FIG. 2, a diagram of the software architecture of FIG. 1, according to one embodiment of the invention, is shown in more detail. The software architecture includes drivers component 12, system services component 14, and user interfaces component 20, the latter which is inclusive of view component 16 and overlays component 18 of FIG. 1. Drivers component 12 specifically includes Microsoft Windows 95 APrs subcomponent 22 and vendor API's subcomponent 24. Microsoft Windows 95 API's subcomponent 22 includes a plurality of drivers 26, while vendor API's subcomponent 24 includes a plurality of drivers 24. System services component 14 specifically includes a plurality of services 30, while user interfaces component includes a plurality of overlays 32 and a plurality of views 34. Each of overlays 32 and views 34 is considered a user interface provided by a corresponding application.

Drivers specifically include and/or provide for in one embodiment of the invention a video display adapter, video capture capability, sound capability, MIDI capability, media control devices (MPEG-2, active movie, video overlay, etc.), video and audio compression CODECs, and modem and communications ports. However, as those of ordinary skill within the art will appreciate, the invention is not limited to such specific drivers.

As shown in FIG. 2, services 30 of system services component 14 include favorite services, channel map services, device control services, opportunities services, view services, EPG data services, parental lock services, TV services, user interface services, logo services, graphics services, and scheduler services. These services act as an abstraction layer to assist in developing views and overlays, and thus simplifying software development, reducing code maintenance, and ensuring greater user interface consistency across applications.

Favorites services provides favorites list management functions, and also a set of common user interfaces for selecting a favorite item from a list, adding an item to a favorite list, and removing an item from a favorite list. Thus, an application calls favorites services when it wishes to add or delete an item such as a channel from a given favorites list. The favorites services provides both the functionality to maintain the favorites list, as well as the user interface to allow a user to add or delete an item from the list. Thus, regardless of which application calls favorites services, the interface presented to the user remains consistent.

Channel map services provides functions for creating a logical tuning space that maps logical channel numbers to physical tuning devices and the specific channel, sub-channel, etc., on the device. For example, a given hardware component in conjunction with which the software architecture operates may have access to a number of channel sources, such as cable TV, broadcast TV, and one or more satellite TV sources. Each of these sources may also have a similar channel mapping, such that cable TV has channels 2-50, broadcast TV has channels 2-13, and satellite TV has channels 2-194.

Thus, specifying a particular channel—for example “channel 2”—does not uniquely identify a given channel, since there may be three channel 2's. Therefore, channel map services alleviates this problem by mapping logical channel numbers to actual channel numbers accessible on the number of channel sources. For example, channel map services may map cable TV channels 2-50 as logical channels 1-49, broadcast TV channels 2-13 as logical channels 50-61, and satellite TV channels 2-194 as logical channels 62-254. Therefore, specifying a particular logical channel always uniquely identifies a given channel. Channel map services is thus called to determine the corresponding physical channel number and the corresponding physical device for a given logical channel number, and vice-versa.

Device control services provides functions for controlling internal convergence hardware and external hardware that is a part of the hardware component in conjunction with which the software architecture operates. The external hardware may be wired directly to other parts of the hardware component, or be controlled via wireless signals, such as infrared signals, in accordance with the IR-Blaster interface or other interfaces known within the art. Device control services also provides common user interfaces for adding and removing new devices and access to specific user interfaces for controlling devices.

Thus, for example, when a given application desires to control a given device such as a digital video disc (DVD) player, a video cassette recorder (VCR), etc., the application calls device control services as opposed to operating the given device itself. If a particular brand of DVD player is subsequently substituted for the initially contemplated brand of DVD player, such that the new VD player is controlled differently than the first DVD player, applications that access or control the DVD player do not need to be rewritten, rather only the specific device control service relating to the DVD player needs to be modified. In cases where upwards of thirty or forty applications all access the same device, this provides for greater efficiency in architecture development, since such applications need not necessarily be rewritten as the hardware that they control changes.

Opportunities services provides functions for managing events that may be of interest to a user, as well as functions for controlling agents that generate these events. Opportunities services also provide a set of user interfaces for controlling the behavior of the agents. The architecture of opportunity services is particularly based on a modular approach in which new opportunity monitoring agents can be added to provide additional sources of events, and thus applications can thus also be added to make use of these events.

For example, opportunity services may provide access to an alarm clock agent, which generates an alarm clock event when the system time of the hardware component in conjunction with which the software architecture is operating is equal to a given predetermined alarm time. Thus, the opportunity service permits a given application to change the predetermined alarm time, to shut off the alarm, to turn on the alarm, etc.

View services provides functions for managing views, navigating between views, and the device control that is necessary when selecting views. View services thus allow a new application to switch the view displayed on a display device of the hardware component in conjunction with which the software architecture is operating from the view corresponding to an initial application to the view corresponding to the new application. That is, a browser program application may use view services to switch the view displayed on the display device from that associated with a different application (such as a TV tuner program) to that associated with the browser program.

EPG data services provides functions for loading electronic program guide-type data from data services. Such data services may be communicated with through a modem, over the Internet, over a satellite, through the vertical blanking interrupt (VBI) of a TV program, etc.; the invention is not so particularly limited. EPG data services also provides a database API for accessing the data and common user interfaces for configuring the loading functions. Thus, an application may use EPG data services to determine what is programmed to be television on a given logical channel at a given time; the EPG data services may then call channel map services to determine the corresponding physical channel and physical device, and then load the relevant EPG if necessary before returning the requested information to the application.

The architecture of the EPG data services is based on a modular approach, such that EPG providers may be added to the EPG database. EPG data services thus provides an abstraction layer between the providers of the EPG data and the application that use the data. If the provider of a given set of EPG data changes, for example, only the relevant EPG data services need to be modified; the applications that utilize these data services do not. The modular nature of the EPG data services also permits the integration of EPG data from multiple sources. For example, EPG data relating to satellite TV may originate from one particular provider, whereas EPG data relating to broadcast TV may originate from another particular provider.

Parental lock services provide a set of functions and user interfaces for managing the access to television content, files, and pay events as well as common user interfaces for password management. For example, a parental lock service may be called to determine whether a particular pay channel on cable TV is allowed to be accessed. Furthermore, a parental lock service may be called to determine whether certain pay channels and other content may be accessible only via entry of the correct password. Thus, an application program or other service may use parental lock services to determine whether access to particular content is permitted.

TV services provide a set of user interface components for watching video, as well as a simplified API for tuning a selected device in a given video window. TV services provides the interface for watching video regardless of the mode in which the hardware component in conjunction with which the software architecture operates is currently configured (for example, either a TV mode or a PC mode, as have been described). TV services specifically manages the relationship among the channel map services, device control services, EPG data services, and parental lock services. An application is able to call TV services to tune to a particular logical channel, TV services then calling channel map services to determine the corresponding device and physical channel, parental lock services to determine whether permission has been given to select that channel, and also device control services to physically tune to the channel on the corresponding device. EPG data services may also be called by TV services as necessary. User interface services and view services may be merged for convenience.

User interface services provides a set of functions to dispatch keyboard, remote control, and other user interface events to the appropriate overlays and views. Thus, when a key on the keyboard has been actuated, or a control on the remote control has been actuated, etc., an appropriate event (such as a hardware interrupt) is generated that is detected and managed by user interface services. User interface services conveys this message to a subscribing overlay or view. A view or overlay (or another service) may thus utilize user interface services to be notified when a particular user interface event occurs.

Logo services provides a set of functions for managing logos used in a particular user interface, such as an overlay or a view, as well as the mapping of logos to different color resolutions and languages. For example, a channel such as ABC or ESPN may have defined within logo services the manner by which its logo is to displayed for a number of color resolutions (i.e., sixteen colors, four colors, one-thousand-twenty-four colors, etc.). An application program or a service calling logo services is thus able to specify a channel for which a logo is needed, as well as the color resolution in which the logo is needed, and the logo services will return the requested logo if available.

Graphics services provides a set of functions for managing common graphics operations. Such common graphics operations including replicating texture bit maps, and mapping bit maps and palettes to different color resolutions, as known within the art. For example, a service or application program may call graphics services, inputting a particular graphic in a given color resolution (e.g., sixteen colors), and request that graphics services return the graphic in another color resolution (e.g., four colors).

Scheduler services provides a set of functions for scheduling timer-related events. Such events include the retrieval of data from an EPG data provider, the notification of a previously scheduled reminder (for example, that a predetermined television program will be broadcast in fifteen minutes), etc. Scheduler services are low-level functions, such that the services and user interfaces (such as views and overlays) calling scheduler services provide their own user interface in conjunction with the timer-related events. That is, scheduler services desirably does not provide a user interface for its events, but rather only manages the events. For example, scheduler services would notify a given service that a particular event has occurred, but would leave it to the given service to graphically display information regarding the event on a display device of the hardware component in conjunction with which the software architecture is operating.

Still referring to FIG. 2, overlays 32 of user interfaces component 20 include a banner overlay, a favorites overlay, a view navigation overlay, a device control overlay, and an opportunities overlay. These overlays desirably appear as a virtual extension of the hardware component in conjunction with which the software architecture operates, and thus not as user interfaces that are specifically part of applications that are running within (and provided by) different views. In other words, overlays are thus not separate views, but rather cooperate with and extend other views. Overlays primarily provide contextual information and a manner by which parts of the hardware component is navigated.

The banner overlay provides a user interface for identifying the content active in the current view. Such content typically includes audio and video information. For example, the banner overlay may identify the channel currently tuned to, the logo of this channel, the current volume level, etc. The banner overlay thus is desirably closely integrated with television services, EPG data services, and logo services, as appreciated by those of ordinary skill within the art.

The favorites overlay provides a user interface for quickly navigating content related to the current view. For example, a given user may have preprogrammed the software architecture such that four favorite logical channels are within the favorite services, the broadcast stations ABC, CBS, NBC, and FOX. The favorites overlay thus provides a user interface so that the user is able to switch quickly among these stations.

The favorites overlay is desirably closely integrated with favorite services, television services, and logo services, as appreciated by those of ordinary skill within the art.

The view navigation overlay provides a user interface for activating other views. For example, a user desiring to switch from the current view to another view does so through the view navigation overlay. The view navigation overlay is desirably closely integrated with view services and logo services, as appreciated by those of ordinary skill within the art. The device control overlay provides a user interface containing a subset of the functionality available in the device control view, described hereafter. The device control overlay permits a user to control devices without leaving the current view. This is distinguished from the device control view, which permits user control of devices only by first switching to the device control view. The device control overlay is desirably closely integrated with device control services and view services, as appreciated by those of ordinary skill within the art.

The opportunities overlay provides a user interface to notify a user of opportunity events. For example, when a telephone device that is a part of the hardware component in conjunction with which the software operates rings, or electronic mail is received, the opportunities overlay presents a user interface to allow the user to take advantage of these opportunities, such as to answer the phone, or read the electronic mail. The opportunities overlay is desirably closely integrated with opportunity services and logo services, as appreciated by those of ordinary skill within the art.

As has been described, several of the overlays have corresponding services with which they are desirably closely integrated. For example, the favorites overlay has corresponding favorites services, the opportunities overlay has corresponding opportunities services, and the device control overlay has corresponding device control services. Such overlays provide a user interface to their corresponding services. This thus separates the user interface aspect of the services into an overlay apart from the functionality provided by the services. Such separation permits easy modification of the user interface aspect—the overlay—without necessarily forcing corresponding modification of the corresponding services, or vice-versa. Such easy modification is an advantage provided by embodiments of the invention.

As shown in FIG. 2, views 34 of user interfaces component 20 include a TV view, a PC view, a home view, an EPG view, a device control view, a web view, a communications view, a games view, and a kids view. These views generally are desirably full-screen graphical user interfaces. However, the software architecture may also provide access to a limited subset of two-view combinations, such as a split-screen web view and TV view. Each view may be associated with a given application program; each application program, however, may support a plurality of views, although the invention is not so limited.

The TV view sets the display device of the hardware component in conjunction with which the system architecture operates into a TV mode, such that a video source is selected and displayed in the view. The video source may be displayed on a full-screen basis. Video sources include a TV tuner, a digital satellite modem, and a DVD player, although the invention is not so particularly limited. The TV view is desirably closely integrated with TV services, as those of ordinary skill within the art will appreciate.

The PC view sets the display device of the hardware component in conjunction with which the system architecture operates into a PC mode, such that a user may use the operating system view, or shell, as provided by the operating system. One such operating system is a version of the Microsoft Windows operating system. Within this view, the hardware component operates similar to other hardware (e.g., a computer) running the same operating system but not having convergence capability, except that the user still has access to overlays, which have been already described.

As those of ordinary skill within the art will appreciate, many of the devices that are a part of the hardware component and that may be accessible through other views, may also be available and accessible through the operating system. For example, within the Microsoft Windows 95 operating system, such devices may be available and accessible from the Start Menu, within the Program Files folder, and within the Control Panel application. While other views may limit window management—i.e., the sizing, overlapping, and moving of windows —the PC view desirably permits full control of the windows.

The PC view is desirably not tightly integrated with any of the system services, as those of ordinary skill within the art will appreciate. However, application programs accessible within the operating system may themselves be integrated with specific services. For example, applications may be integrated with TV services, EPG data services, and parental lock services in particular.

The home view provides a single location to assess (view) the available convergence content available within the hardware component in conjunction with which the system architecture operates. Thus, accessing the home view permits a user to learn that, for example, the convergence content on a particular hardware component includes a PC mode, and a TV mode, such that the TV mode permits access to cable TV and satellite TV. Furthermore, the home view displays video from the favorite channels, the available opportunities, representations (“peeks”) at other views, etc.

The home view is considered a convergence application since all content available within the hardware component is accessed and available through the home view. The home view is desirably closely integrated with all the system services, and in particular TV services, favorites services, and opportunities services, as those of ordinary skill within the art will appreciate.

The EPG view provides a program grid, a preview video window, and information about the current program or other programs in the grid. Thus, the EPG view provides a content-centric manner by which the hardware component in conjunction with which the software architecture operates may be navigated. A user is able to navigate the EPG information as displayed in the EPG view to learn, for example, what TV programs will be displayed and at what times, etc. The EPG view is desirably closely integrated with EPG data services, TV services, logo services, and scheduler services, as those of ordinary skill within the art will appreciate.

The device control view provides user interfaces for each multimedia, audio, and video device within the hardware component in conjunction with which the software architecture operates. Such devices may be coupled within the hardware component via physical connection (hard-wired), or wirelessly (e.g., via infrared signals). As compared to the EPG view, the device control view provides a device-centric manner by which the hardware component may be navigated. The user interfaces for each device provide controls for operating the device, which desirably are typically limited to the controls normally found on a remote control for the device. As those of ordinary skill within the art will appreciate, the device control view is desirably closely integrated with device control services, favorites services, and TV services.

The web view provides a user interface for browsing Internet world-wide-web pages. The interface provided by the web view may be that as provided by the computer program Netscape Navigator, or the computer program Microsoft Internet Explorer, as known within the art. The web view is desirably closely integrated with favorites services and parental lock services, as those of ordinary skill within the art will appreciate.

The communications view provides a user interface to access various communications capabilities available within the software architecture and/or the hardware component in conjunction with which the software architecture operates. Such communications capabilities may include speaker phone, video phone, facsimile, electronic mail, and telephone answering machine capabilities. Thus, an application program wishing to utilize one of these communications capabilities may call the communications view to utilize the user interface provided by this view. As those of ordinary skill within the art will appreciate, the communications view is desirably closely integrated with favorites services, parental lock services, and logo services.

The games view provides a user interface for navigating entertainment programs that may be included on the computerized system including the hardware component in conjunction with which the software architecture operates. Furthermore, the games view provides a user interface to permit a user to add a new game to the computerized system, from a device that is a part of the hardware component, such as a CD-ROM drive. As those of ordinary skill within the art will appreciate, the games view is desirably closely integrated with favorites services, parental lock services, and logo services.

The kids view provides a user interface to simplify functionality provided by the computerized system, including the software architecture and the hardware component in conjunction with which the software architecture operates. That is, the kids view provides a user interface that limits access to functions and files that may be inappropriate to children, such that the entire computerized system is more easily used by children. As those of ordinary skill within the art will appreciate, the kids view is desirably closely integrated with favorites services, parental lock services, and TV services.

As has been described, many of the views are desirably closely integrated with one or more services. This enables such views to combine the functionality provided by these services, in an easily accessible user interface. Besides easing development of such application programs, the utilization of views ensures a consistent user interface for such combined functionality—by accessing a given view, all such application programs utilize the user interface provided by this view, ensuring that the user interface for this combined functionality is consistent regardless of the application program accessing the view. If each application program instead provided its own user interface for this combined functionality, the potential for and probability of inconsistent user interfaces is high.

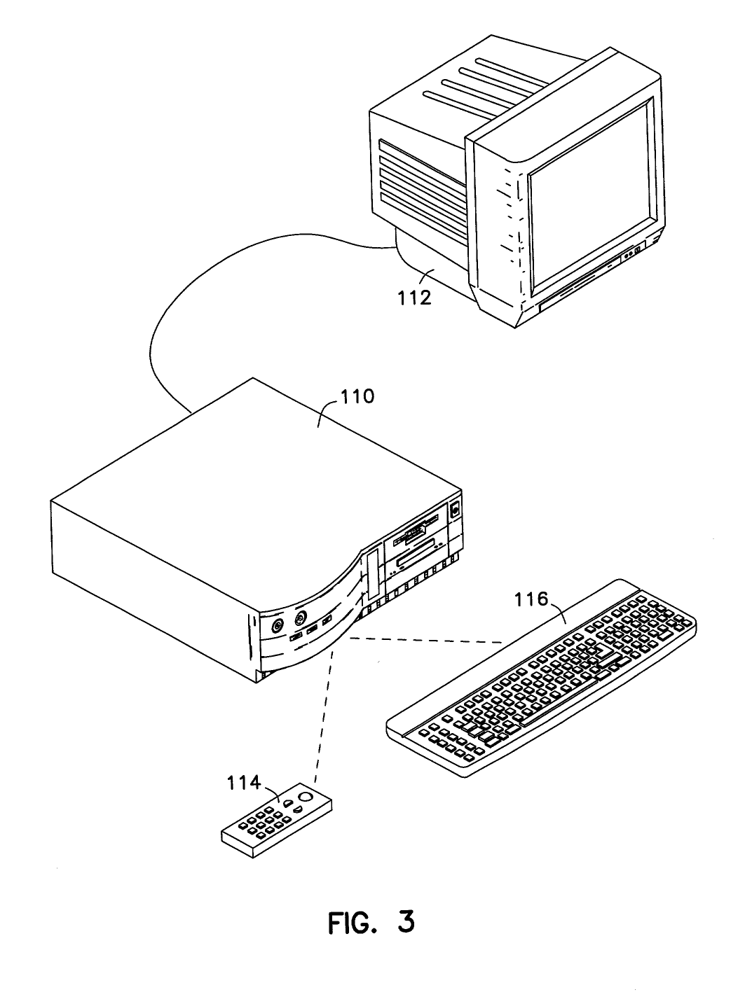

Referring next to FIG. 3, a diagram of a typical computer in conjunction with which embodiments of the invention may be implemented is shown. Computer 110 is operatively coupled to monitor 112, pointing device 114, and keyboard 116. The computerized system provides the hardware component and the software architecture as has been described herein. Computer 110 includes a processor (preferably, an Intel Pentium processor), random-access memory (RAM) (preferably, at least thirty-two megabytes), read-only memory (ROM), and one or more storage devices, such as a hard disk drive, a floppy disk drive (into which a floppy disk can be inserted), an optical disk drive, and a tape cartridge drive. The memory, hard drives, floppy disks, etc., are types of computer-readable media. The invention is not particularly limited to any type of computer 110. Computer 110 preferably is a PC-compatible computer running a version of the Microsoft Windows operating system. The construction and operation of such computers are well known within the art.

Computer 110 includes integrated therein or coupled thereto hardware to provide for what is known as the art as a “convergence environment” such that computer 110 provides capability beyond ordinary PC operation. Such capability preferably including TV capability. For example, the Gateway Destination PC/TV system, available from Gateway 2000, Inc., provides a convergence environment across two primary modes of operation: TV viewing, and PC operation. Computer 110 desirably provides for integration with or includes audio/visual (i.e., multimedia) devices including but not limited to: a sound card, a digital video disc (DVD) player, a direct broadcast satellite (DBS) receiver, a TV tuner (for broadcast and/or cable TV), audio/visual inputs for external or auxiliary devices, a CD-ROM player, an audio/visual tuner having at least radio tuning capability, a cable decoder, a video cassette recorder, a laser disc player, a compact disc player, a DBS integrated receiver-decoder (IRD), and a video camera.

Computer 110 may also be communicatively connected to the Internet, any particular manner by which the invention is not limited to, and which is not shown in FIG. 1. Internet connectivity is well known within the art. In one embodiment, the computer includes a modem and corresponding communication drivers to connect to the Internet via what is known in the art as a “dial-up connection.” In another embodiment, the computer includes an Ethernet or similar hardware card to connect to a local-area network (LAN) that itself is connected to the Internet via what is know in the art as a “direct connection” (e.g., T1 line, etc.).

Monitor 112 permits the display of information, including computer, video and other information, for viewing by a user of the computer. The invention is not limited to any particular monitor 112. Such monitors include cathode ray tube (CRT) displays, as well as flat panel displays such as liquid crystal displays (LCD's). The monitor is, however, desirably a 31″ VGA monitor. Pointing device 114 permits the control of the screen pointer provided by the graphical user interface of operating systems such as versions of Microsoft Windows. The invention is not limited to any particular pointing device 114, and may include a plurality of pointing devices. Such pointing devices include mouses, touch pads, trackballs, remote controls and point sticks. For example, the remote control has a number of keys that may be used for text entry. Finally, keyboard 116 permits entry of textual information into computer 110, as known within the art, and the invention is not limited to any particular type of keyboard. Desirably, keyboard 116 is a wireless keyboard.

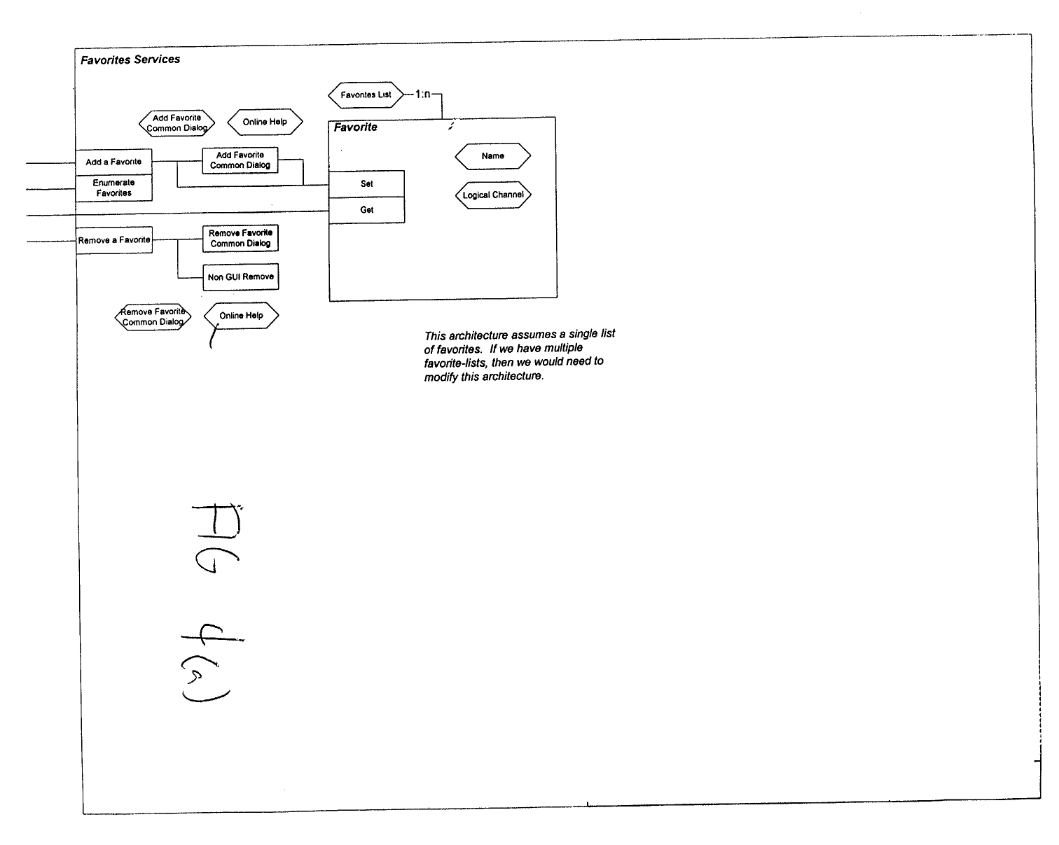

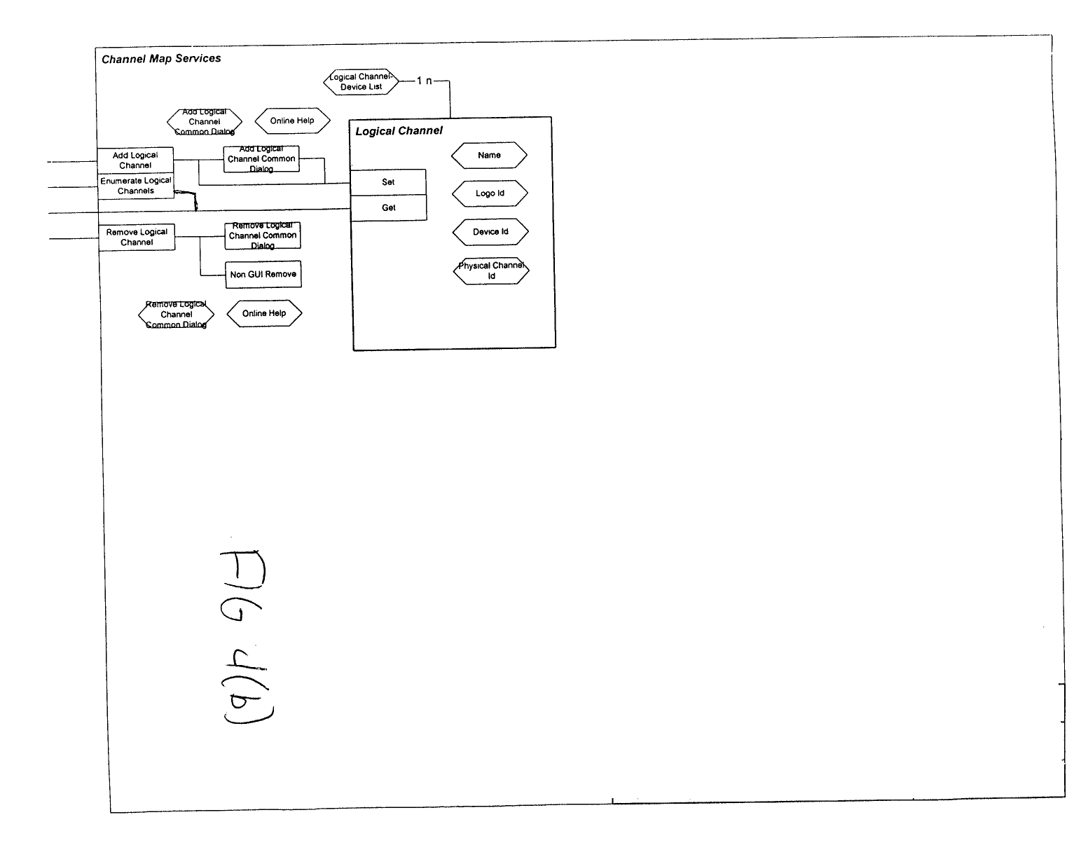

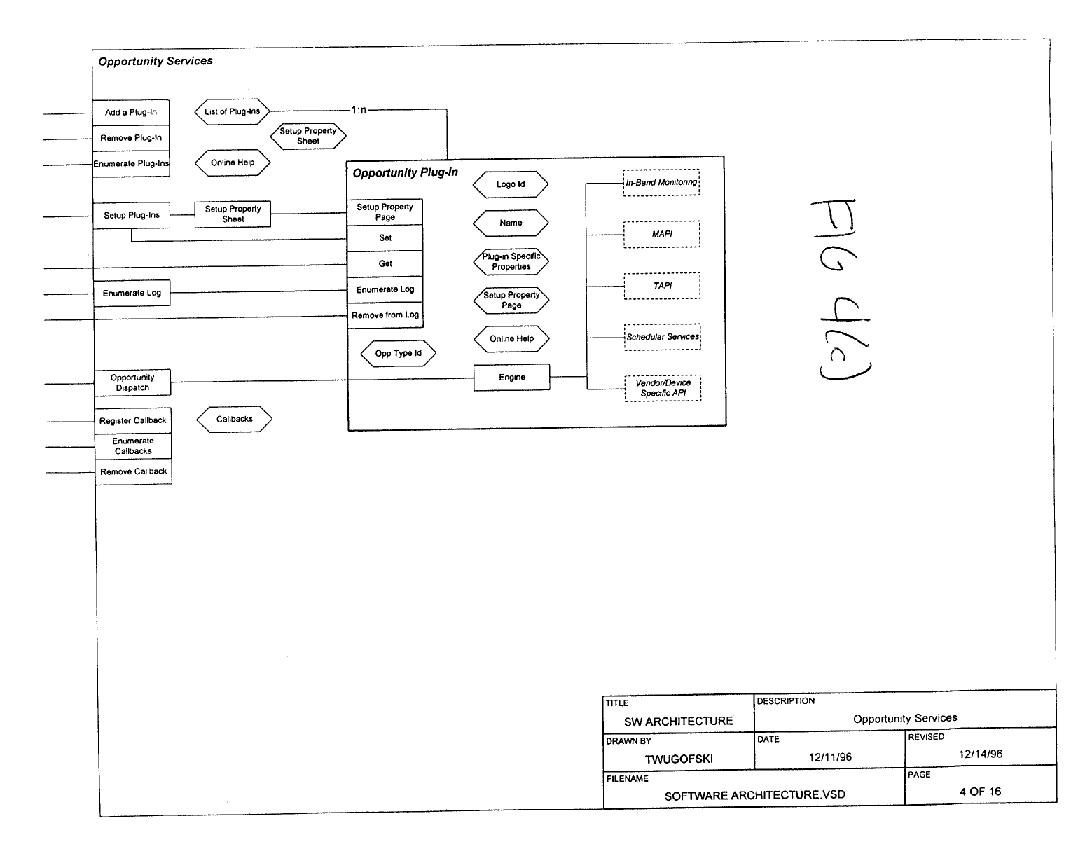

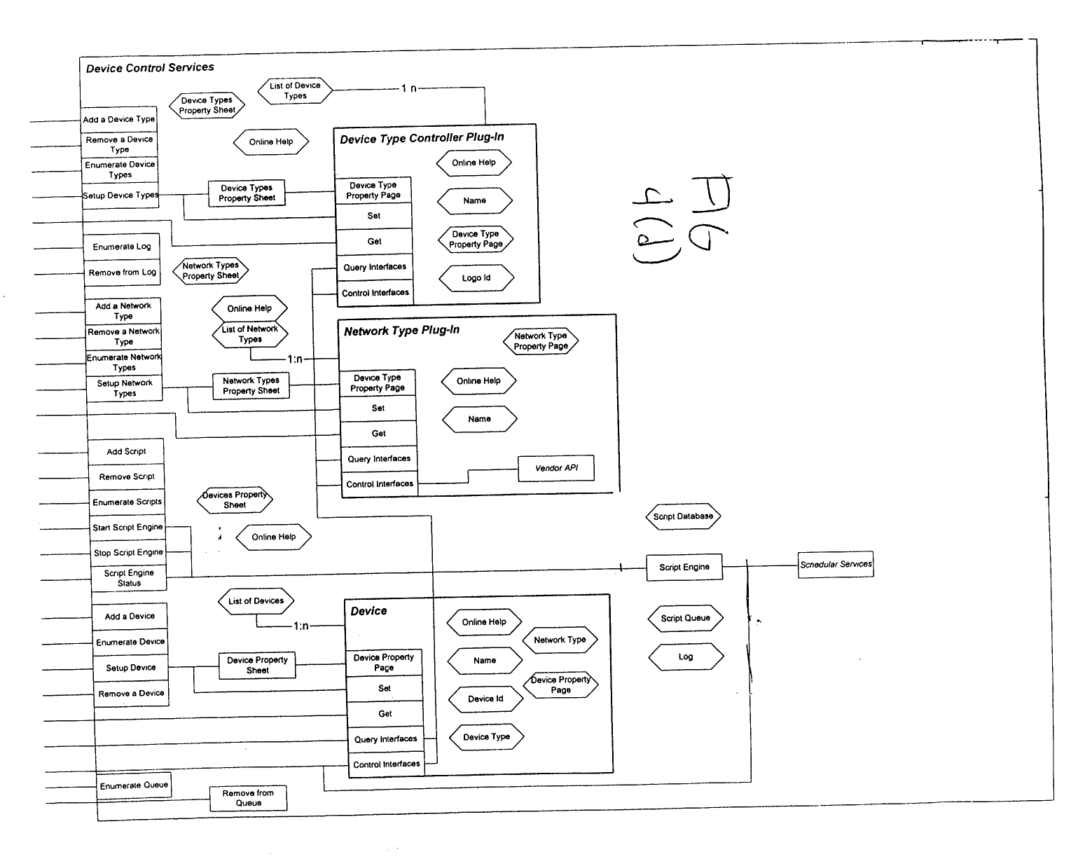

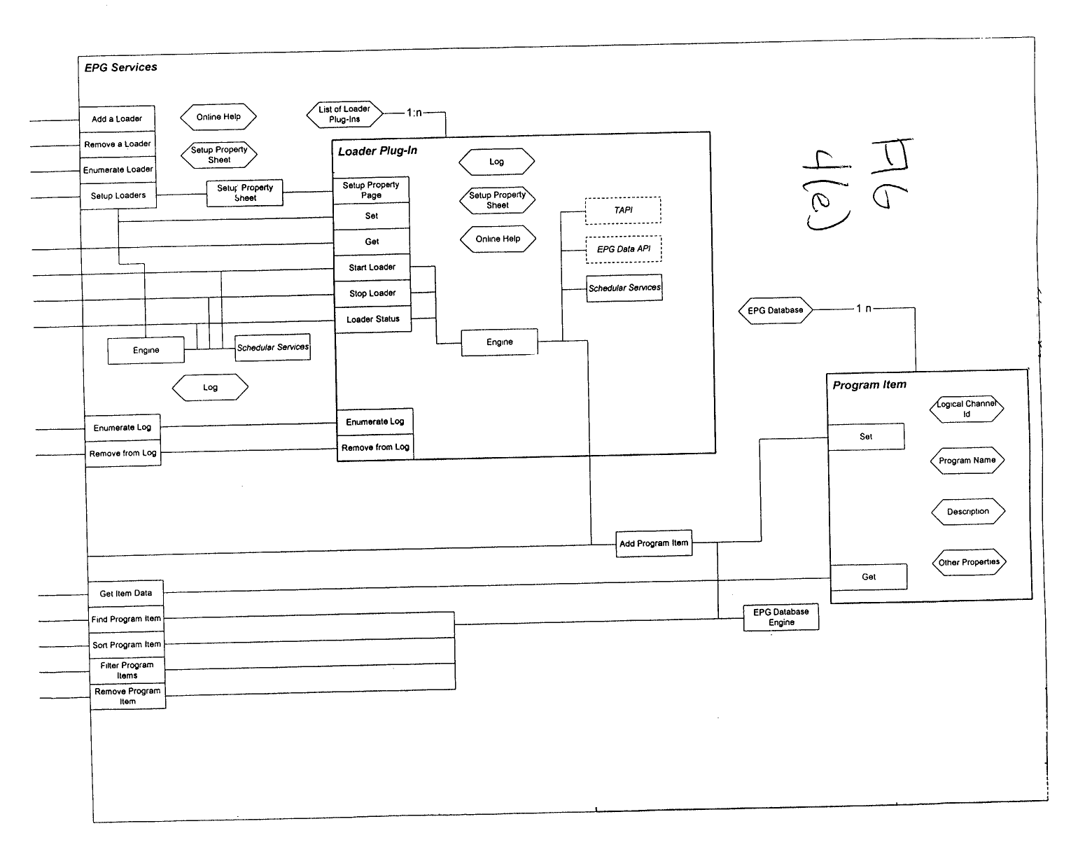

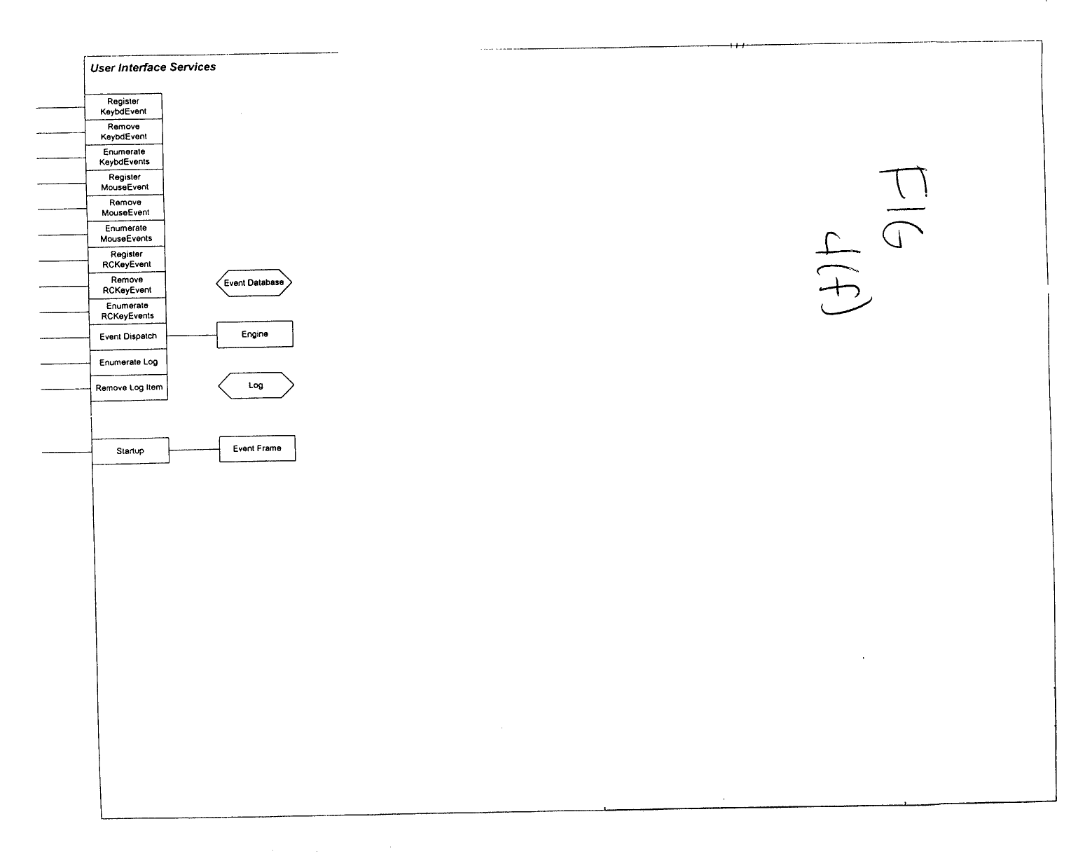

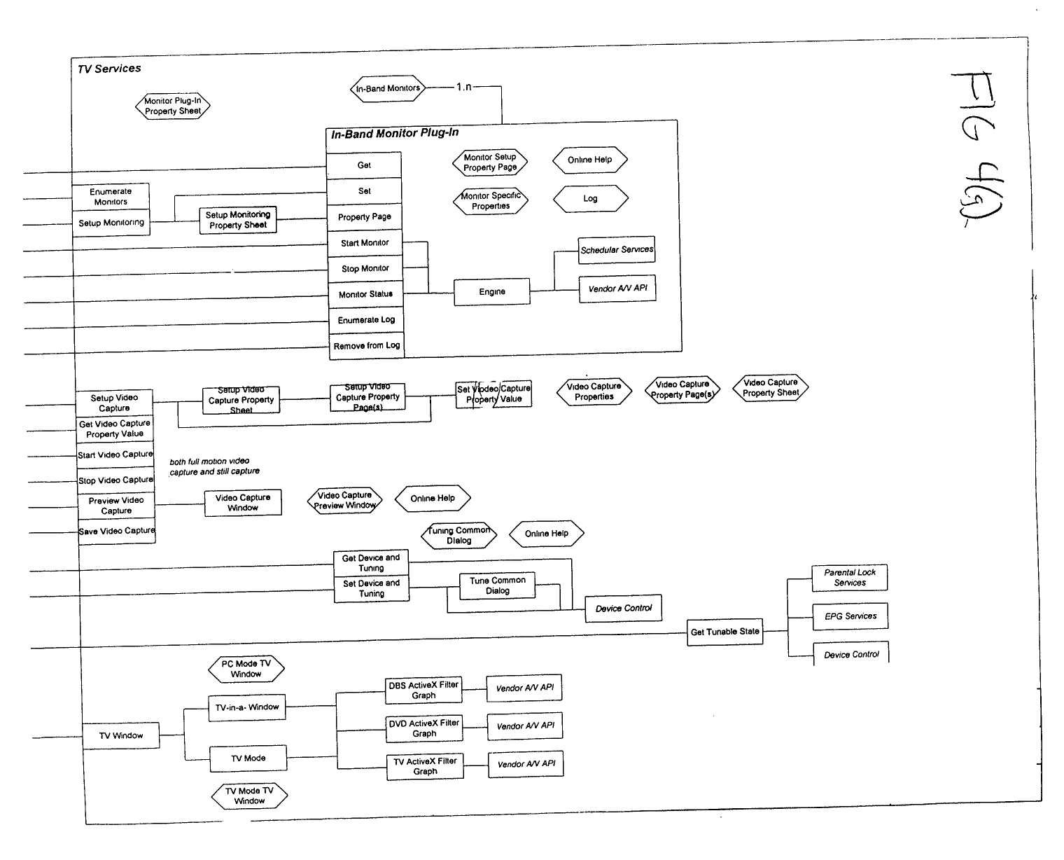

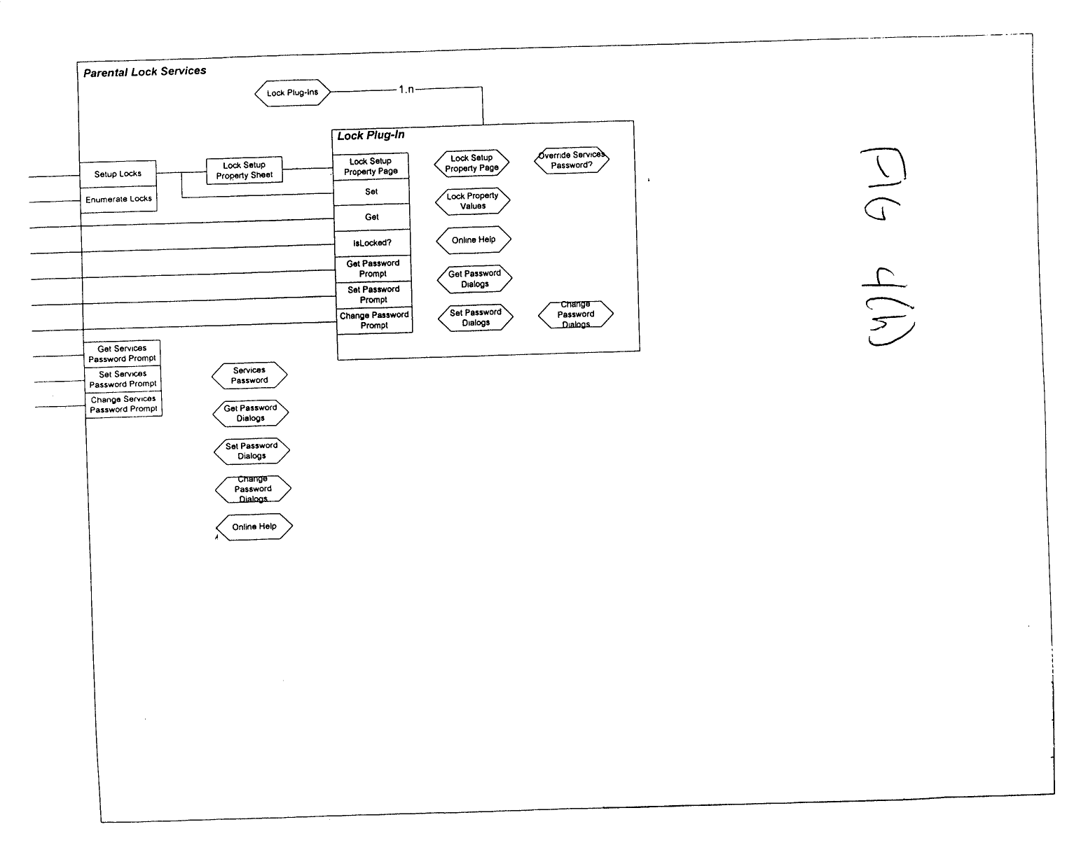

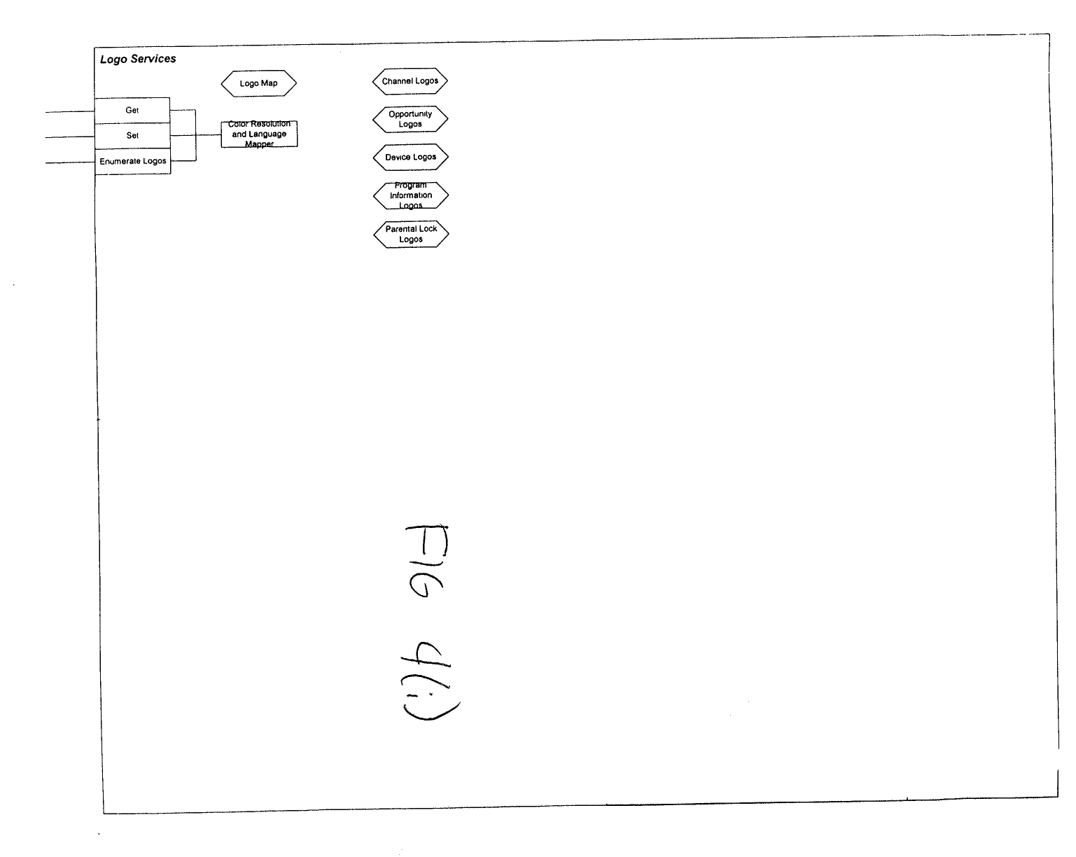

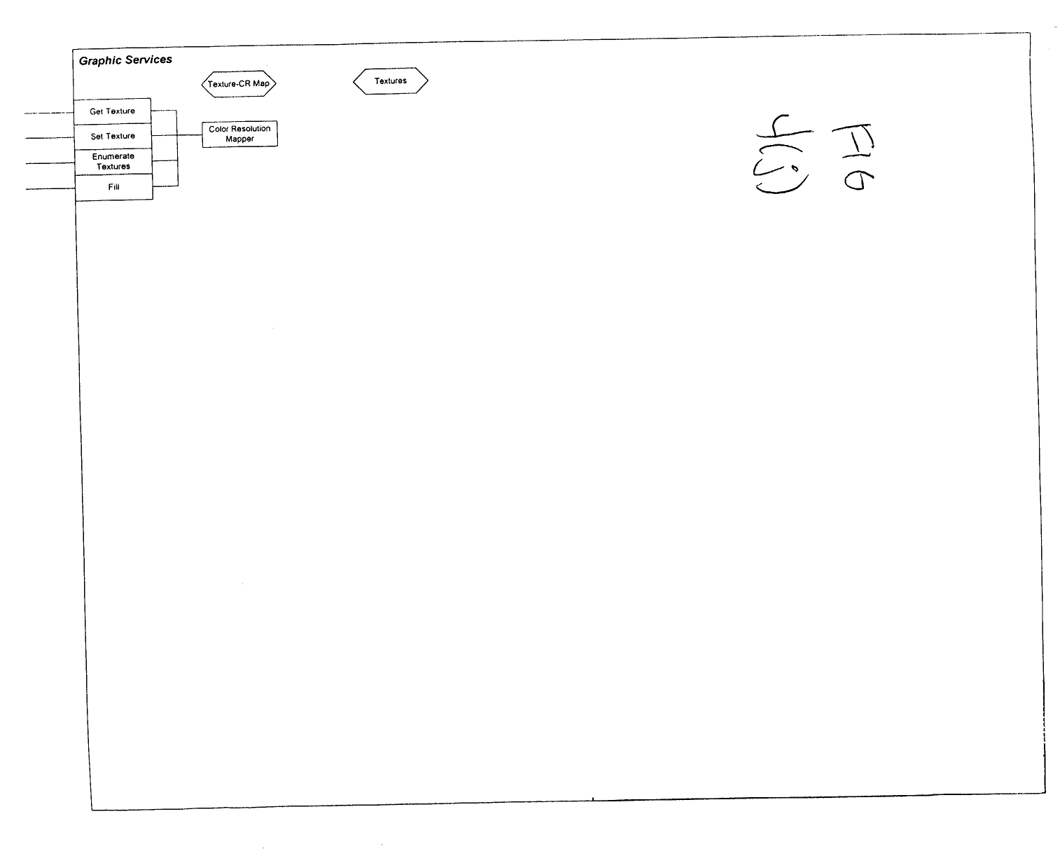

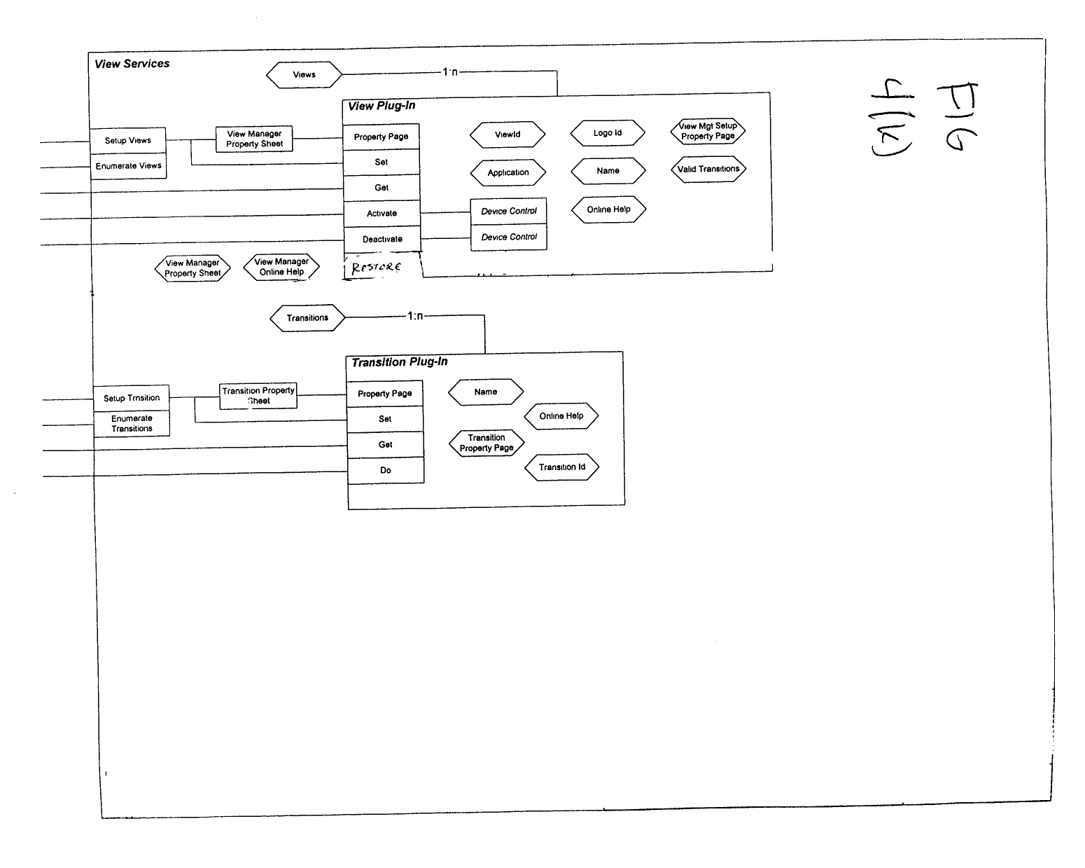

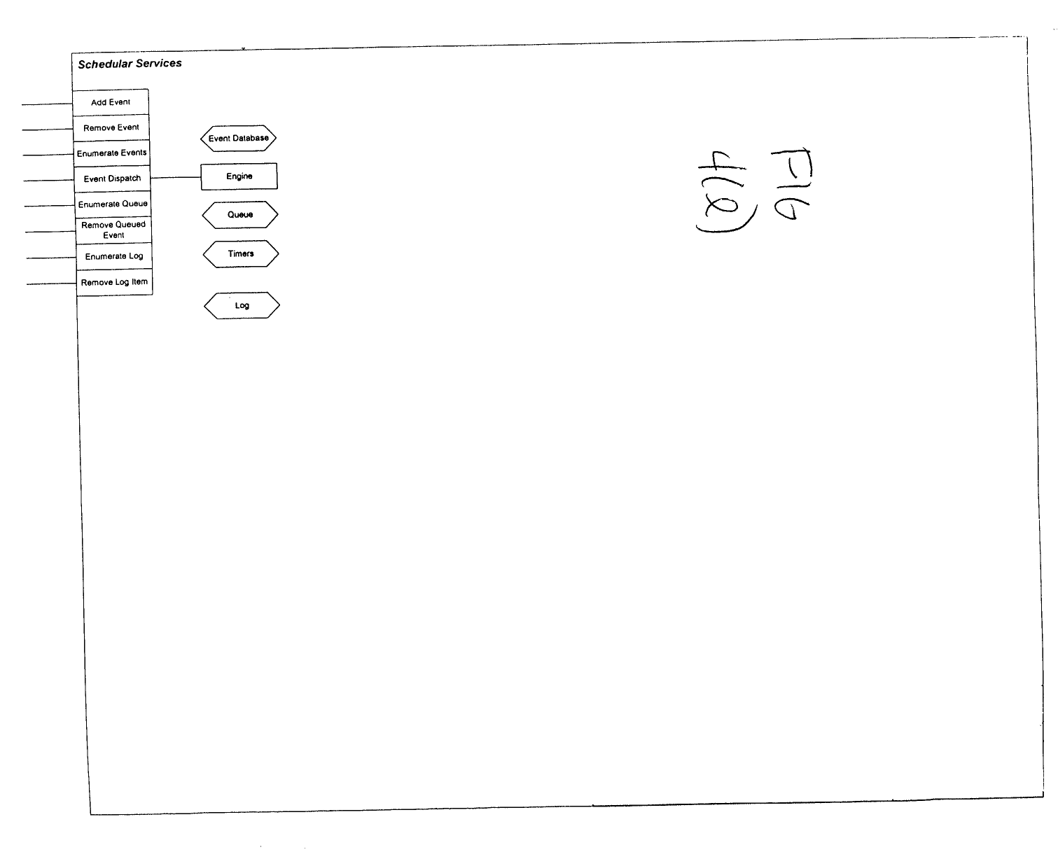

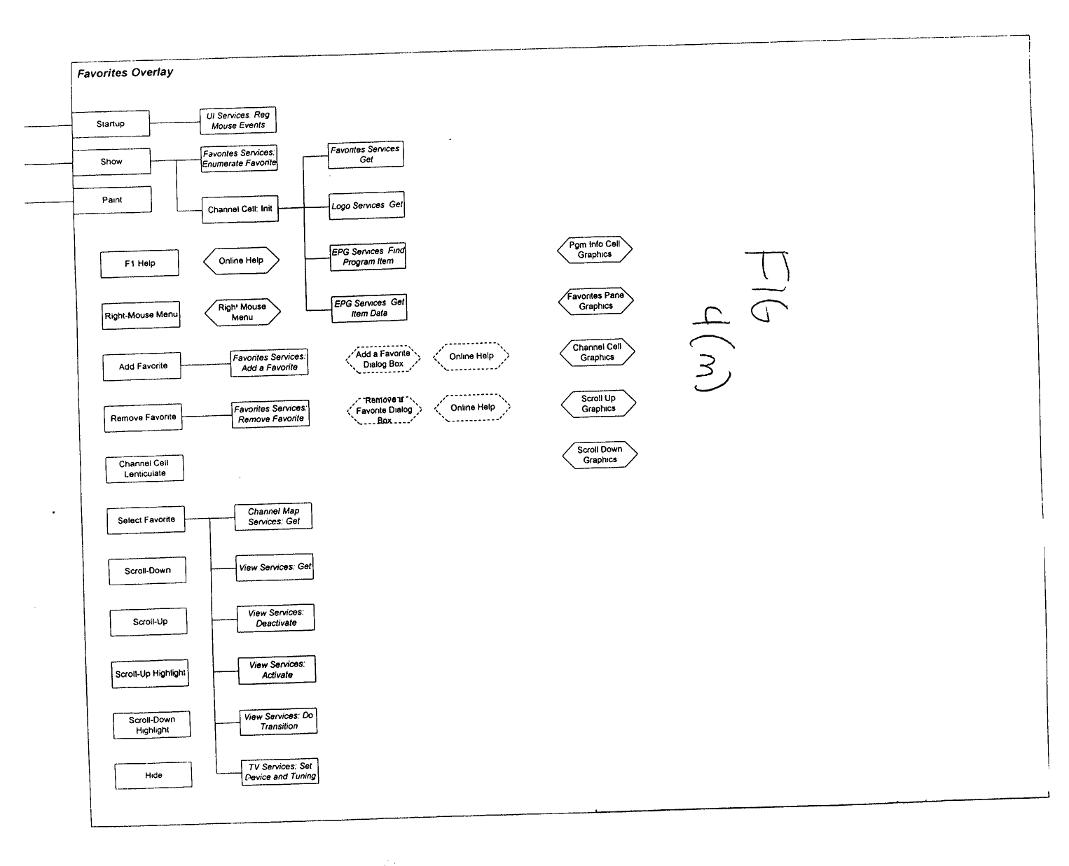

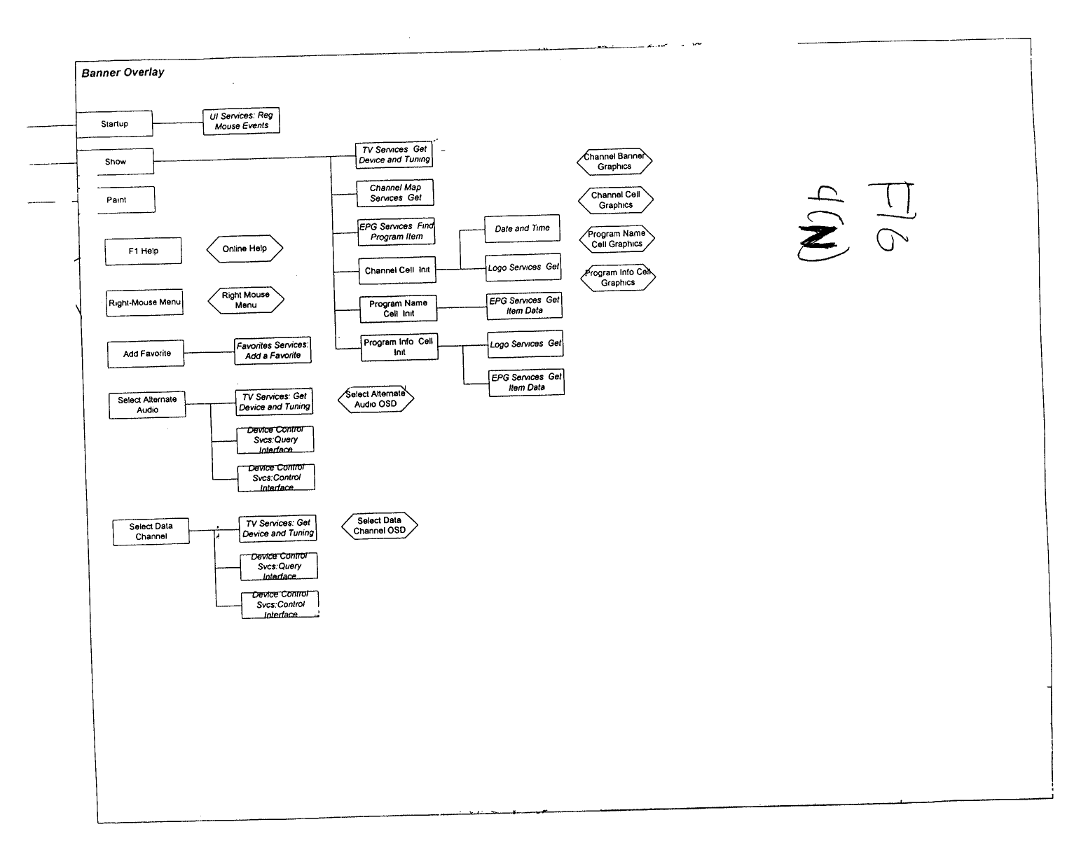

Referring finally to FIGS. 4(a)-4(n), diagrams showing in more detail a software architecture according to one embodiment of the invention are shown. These diagrams are shown to illustrate the manner by which a software architecture may be implemented, and the invention is not so limited. Furthermore, those of ordinary skill within the art will readily understand and comprehend the figures, and therefore only a brief description thereof is provided here. The lines extending outwards (and not ending in a box) representing input and output functionality of a given service—that is, the input and output that is provided by the given service. Rectangular boxes represent the logic performing a given functionality by the given service. Finally, hexagonal boxes represent data, dialog boxes, as known within the art, or other data.

FIG. 4(a) specifically relates to favorites services. FIG. 4(b) specifically refers to channel map services. FIG. 4(c) specifically refers to opportunity services. FIG. 4(d) specifically refers to device control services. FIG. 4(e) specifically refers to EPG services. FIG. 4(f) specifically refers to user interface services. FIG. 4(g) specifically refers to TV services. FIG. 4(h) specifically refers to parental lock services. FIG. 4(i) specifically refers to logo services. FIG. 4(j) specifically refers to graphic services. FIG. 4(k) specifically refers to view services. FIG. 4(l) specifically refers to scheduler services. FIG. 4(m) specifically refers to favorites overlay. Finally, FIG. 4(n) specifically refers to banner overlay.

Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the present invention. Therefore, it is manifestly intended that this invention be limited only by the following claims and equivalents thereof.

I claim:

1. A computerized convergence system comprising:
a hardware component providing a convergence environment;
a drivers component providing low-level functionality and cooperating directly with the hardware component;
a view component providing graphical user interface contexts;
an overlay component providing partial screen graphical user interfaces consistent across the graphical user interface contexts provided by the view component; and,
a system services component interfacing with the drivers component and providing common functionality and user interfaces shared by the view component and the overlay component.

2. The computerized system of claim 1, wherein the convergence environment provided by the hardware component includes PC capability and TV capability.

3. The computerized system of claim 1, wherein the drivers component includes application programming interfaces (API's).

4. The computerized system of claim 1, wherein at least one of the graphical user interface contexts provided by the view component comprises a full-screen graphical user interface.

5. The computerized system of claim 1, wherein at least one of the partial screen graphical user interfaces provided by the overlays component is displayed regardless of the context currently provided by the view component.

6. The computerized system of claim 1, wherein the drivers component acts as a first hardware abstraction layer between the hardware component and the system services component, the view component, and the overlays component, and the system services component acts as a second hardware abstraction layer between the drivers component and both the view component and the overlays component.

7. A convergence software architecture comprising:
a plurality of views, each view providing a graphical user interface;
a plurality of overlays, each overlay providing a partial graphical user interface cooperating with the plurality of views;
a plurality of system services, each system service providing at least one of common functionality and common user interfaces shared by the plurality of views and the plurality of overlays.

8. The software architecture of claim 7, further comprising a plurality of drivers, each driver acting as a layer of hardware abstraction between hardware in conjunction with which the system architecture operates and at least one of the plurality of views, the plurality of overlays, and the plurality of system services.

9. The software architecture of claim 7, wherein the plurality of system services includes at least one system service selected from the group of system services consisting of: favorite services, channel map services, device control services, opportunities services, view services, EPG data services, parental lock services, TV services, user interface services, logo services, graphics services, and scheduler services.

10. The software architecture of claim 7, wherein the plurality of overlays includes at least one overlay selected from the group of overlays consisting of: a channel banner overlay, a favorites overlay, a view navigation overlay, a device control overlay, an opportunities overlay, and a menu overlay.

11. The software architecture of claim 7, wherein at least one overlay has a corresponding system service, such that the overlay provides a user interface for the corresponding system service.

12. The software architecture of claim 7, wherein the plurality of views includes at least one view selected from the group of views consisting of: a TV view, a PC view, a home view, an EPG view, a device control view, a web view, a communications view, a games view, and a kids view.

13. The software architecture of claim 7, wherein at least one view is closely integrated with at least one system service, such that the view combines functionality provided by the system services in the graphical user interface provided by the view.

14. A computer comprising:
a processor;
a computer-readable medium;
at least one multimedia device; and,
a software architecture executed by the processor from the computer-readable medium to provide a convergence environment associated with at least one multimedia device, the architecture including driver, view, overlay, and system service components operatively coupled to one another.

15. The computer of claim 14, wherein the view component provides graphical user interface contexts and includes a plurality of views, each view providing a graphical user interface.

16. The computer of claim 15, wherein the overlay component provides partial screen graphical user interfaces consistent across the graphical user interface contexts and includes a plurality of overlays, each overlay providing a partial graphical user interface cooperating with the plurality of views.

17. The computer of claim 16, wherein the system services component provides common functionality and user interfaces shared by the view component and the overlay component and includes a plurality of system services, each system service providing at least one of common functionality and common user interfaces shared by the plurality of views and the plurality of overlays.

18. The computer of claim 17, wherein the driver component provides low-level functionality and cooperates directly with the at least one multimedia device and includes a plurality of drivers, each driver acting as a layer of hardware abstraction between the at least one multimedia device and at least one of the plurality of views, the plurality of overlays, and the plurality of system services.

19. A computer-readable media having a computer program stored thereon providing a convergence system architecture comprising:
a plurality of views, each view providing a graphical user interface;
a plurality of overlays, each overlay providing a partial graphical user interface cooperating with the plurality of views;
a plurality of system services, each system service providing at least one of common functionality and common user interfaces shared by the plurality of views and the plurality of overlays.
